(19) United States
(12) Patent Application Publication
(10) Pub. No.: US 2006/0177022 A1
(43) Pub. Date: Aug. 10, 2006

(54) Voice message processing system and method

(75) Inventors: Sun-Loi Lai, Taipei (TW); Shih-Hsiung Weng, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/053,691

(22) Filed: Feb. 7, 2005

(51) Int. Cl. H04M 11/00

(52) U.S. Cl. 379/88.14

(57) ABSTRACT

The present invention proposes a voice message processing system and method employed to convert voice message received by a network phone into text message to be outputted by a network device connected to the network phone, the network phone interconnecting the network device via a network server, so that the network server sends the voice message received by the network phone to the network device such as a facsimile apparatus for outputting the text message. Firstly, the user designates a communication number of a network device via the network server for the network device to receive a message from the network phone; the network phone receives the voice message, and the network server converts the voice message into a text message and sends the converted message to the designated network device; and the network server commands the designated network device to output the text message.

### FIELD OF THE INVENTION

The present invention relates to voice message processing systems and methods, and more specifically, to a voice message processing system and method that converts voice information received by voice over Internet Protocol (VoIP) into text information.

### BACKGROUND OF THE INVENTION

With the trend of globalization, many enterprises operate by locating different departments around the world, for example, sales department in USA, research and development center in Taiwan, and manufacturing base in China, thereby maximizing enterprises' profits via exploiting best resources around the world. As a result, real time communication between staff in offices of different locations becomes very important, and Voice over IP (VoIP) network phone has been deployed by international enterprises as the communication medium, due to prevalence of the Internet.

VoIP telephony compresses voice signals into data packets, and sends voice service over an IP network, that is, VoIP is a telecommunication application service system that sends voice via the Internet. Consequently, in order to use network phones for communication, user sets up a network phone system with a plurality of network phones arranged therein, so that users can communicate in speech using these network phones.

For these international enterprises, each of the network phones often records incoming voice messages from customers and other important business-related voice messages, such as message for important conference calls and the like. If the user wants to receive a voice message from the network phone, he has to access the voice message at a place where the network phone present. However, the user cannot receive the voice message of the network phone somewhere else, which brings a lot of inconvenience to the user.

In addition, even if the user gets access to the network phone and replays the desired voice message in order to receive information needed, a lot of problems still exist, for example, some information of the voice messages may be neglected, lost or forgotten because the user is absent mind or having trouble hearing due to noisy environment. Furthermore, regarding the voice message per se, the user may incompletely receive the voice message because of unstable transmission of the Internet. Additionally, if the voice message is made from a Chinese speaker, while receiver of the voice message has little Chinese comprehension skill, it can be even more difficult to receive the voice message correctly. Thus, for the network phone user who can not hear clearly or has poor comprehension skill of a certain language, problems may arise and may obstacle the intercommunication of the users using the network phone, or even worse, an international enterprise may suffer considerable economic lose because of the obstacle in intercommunication of voice messages.

Moreover, regarding very important voice messages, for example associates meetings held or conversation by customers via network phones, users may need to select a sentence, a paragraph or the whole length of the voice message to be converted into corresponding text messages for those absentee. Furthermore, under some circumstances, the voice messages having been listened to, or being listened to, their text form may need to be printed out for archive, so that they become more useful reference materials.

Consequently, there still exist problems to be solved on how to generate text messages corresponding to the voice messages received by VoIP network phone, and to allow those users having no direct access to the network phone to remotely and conveniently obtain the corresponding text message.

### SUMMARY OF THE INVENTION

Regarding the drawbacks of the above-mentioned conventional methods, the primary objective of the present invention is to provide a voice message processing system and method, which converts voice messages received by network phones into corresponding text messages, enabling those users who cannot listen to the voice messages, or cannot fully comprehend the language used in the voice messages to access the textual contents of the voice messages.

Another objective of the present invention is to provide a voice message processing system and method, which is employed in a network system constructed between a network phone and a network device via a network server, thereby sending via the network server voice messages received by the network phone (partial or whole length) to the network device that outputs the corresponding text messages, such as an facsimile apparatus prints out the voice messages received by the network phone.

Yet another objective of the present invention is to provide a voice message processing system and method, which coverts voice messages received by a network phone into corresponding text messages, enabling a remote network device to receive the content of the voice messages, so that the messages received via the network phone can be represented in forms other than only that provided by the network phone.

In accordance with the above and other objectives, the present invention proposes a voice message processing system and method. The voice message processing system converts a voice message received by a network phone into a text message to be outputted by a network device connected to the network phone.

The voice message processing system comprises a voice message receiving module for receiving a voice message from the network phone; a designating module for designating the communication number representing the network device; a voice to text conversion module for converting the voice message received by the voice message receiving module into text message to be outputted by the network device; and a sending module for sending the text message converted by the voice to text conversion module to the network device having a communication number designated by the designating module, so that the network device outputs the voice message received by the network phone in textual form.

The above-mentioned network phone interconnects the network device via the network server. The voice receiving module, the designating module, the voice to text conversion module and the sending module are arranged in the network server, so that the network server sends the voice message received by the network phone to the network device outputting the corresponding text message. The network device can for example be a facsimile apparatus, which prints out the text message corresponding to the voice message.

The voice message processing method is applied to the above voice message processing system. The voice message processing method comprises the steps of: a user designating via the network server a communication number of a network device for receiving a voice message from the network phone; the network phone receiving the voice message; the network server converting the voice message into text message to be outputted by the network device; and the network server commanding the network device having designated communication number to output the text message converted by the network server.

The voice message processing system and method further arranges a voice message transfer unit in the network server for storing the address of a user-selected voice message to be converted into text message, so that the network server converts the particular voice message of the network phone indicated by the voice message transfer unit into text message, and the network server sends the converted text message to the network device, such as a facsimile apparatus for printing out.

In addition, the voice message processing system and method of the present invention further comprises a character database unit for storing a plurality of characters in different language, thereby allowing the voice messages to correspond to characters of various language (e.g. English, Chinese, or Japanese etc.), so that users who cannot understand the language used in the original message will now be able to understand the message.

The present invention is described in the following with specific embodiments, so that one skilled in the pertinent art can easily understand other advantages and effects of the present invention from the disclosure of the invention. The present invention is also implemented and applied according to other alternative embodiments, where details are modified based on applications without departing from the spirit of the invention.

### BRIEF DESCRIPTION OF THE DRAWINGS

FIG. 1 is a block diagram showing a basic architecture of a voice message processing system in accordance with a preferred embodiment of the present invention;

FIG. 2 is a block diagram showing basic function modules of a network phone server of the voice message processing system in accordance with the preferred embodiment of the present invention; and

FIG. 3 is a flow chart showing the procedures for a voice message processing method in accordance with the preferred embodiment of the present invention.

### DETAILED DESCRIPTION OF THE PREFERRED EMBODIMENTS

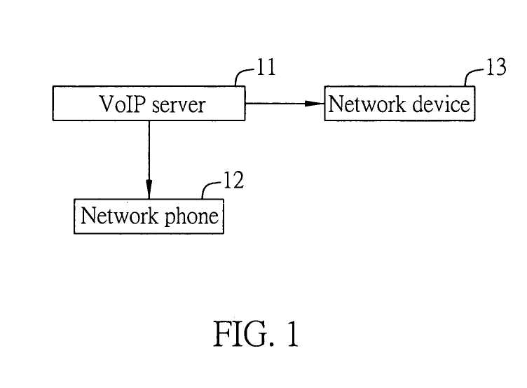

Referring to FIG. 1, a block diagram showing a basic architecture of a voice message processing system in accordance with a preferred embodiment of the present invention is illustrated. As shown in the drawing, the voice message processing system in accordance with the embodiment of the present invention comprises: a VoIP server 11, at least a network phone 12 and a network device 13 connected to the VoIP server.

The VoIP server 11 serves as a communication medium between the network phone 12 and the network device 13. User can designate a communication number of a network device via the VoIP server 11, so that voice message(s) received by the network phone 12 can be sent to the network device 13 having the communication number, and the text form of the voice messages received by the network phone 12 can be outputted by the network device 13. Specifically, the user can provide the communication number to the network phone 12, which then sends the communication number to the VoIP server 11; or the communication number can be provided by the network device 13 itself to be logged on to the VoIP server 11; or the communication number can be input via the VoIP server 11 itself or other electronic devices (not shown) connected to the VoIP server 11 for designating the communication number in the VoIP server 11.

The network phone 12 connects to the above-mentioned VoIP server 11 for providing voice messages to the VoIP server 11. The voice messages can be the voice messages received by the network phone 12, or can be the voice messages not received by the network phone 12 but later stored in the network phone 12 in appropriate means, for example, voice massages recorded by the network phone 12 serving as an answering machine, or voice data provided by a portable voice disk arranged in the network phone 12. The voice messages received by the network phone 12 can be the whole voice content of a communication, or can be part of the voice content after editing or voice content in a period of time, and which is not limited to those defined here. However, no matter how the voice message is defined, each of the stored voice messages has a start address and an end address in the voice data unit of the network phone 12; the start address and end address are employed to define an integrated voice message; and the addresses can be used by a programmer to locate the voice message in the voice data unit, which will be detailed in the following description.

The network device 13 can be a network facsimile apparatus or network printer, which is connected to the above mentioned VoIP server 11 in response to the communication number designated by the VoIP server 11, thereby the network device 13 having the communication number prints out the corresponding text messages of the voice messages sent by the network phone 12 via the VoIP server 11, that is, the network device 13 outputs the messages in a hardcopy form. Alternatively, a copying device (not shown), such as CD-ROM driver and disk driver, is arranged in the network device 13, so that the network device 13 stores the text messages corresponding to the voice messages sent by the network phone 12 to the copying device for keeping the material in an electronic file form. In addition, the network device 13 can also be an electronic device outputting text messages and connected to the VoIP server 11, such as computer, handheld computer, PDA and so on. The network can be connected via internet, intranet, extranet, WAV, LAN, satellite communication network and so on, which is not limited to those mentioned here.

The above VoIP server 11, network phone 12 and network device 13 can be located in the same area, or can be located in different areas, that is, the network device 13 can be arranged remotely from the network phone 12, and which is not limited to those mentioned above. Consequently, in the voice message processing system of the present invention, network connection can be formed between the network phone 12, the VoIP server 11 and the network device 13. Thus, the voice messages received by the network phone 12 can be converted into text messages via the VoIP server 11 for outputting by the network device 13 (can be located remotely from the network phone 12), therefore the messages of the network phone 12 can be received by devices including but not limited to only the network phone 12. Also, the messages will not be limited to only the voice form provided by the network phone 12.

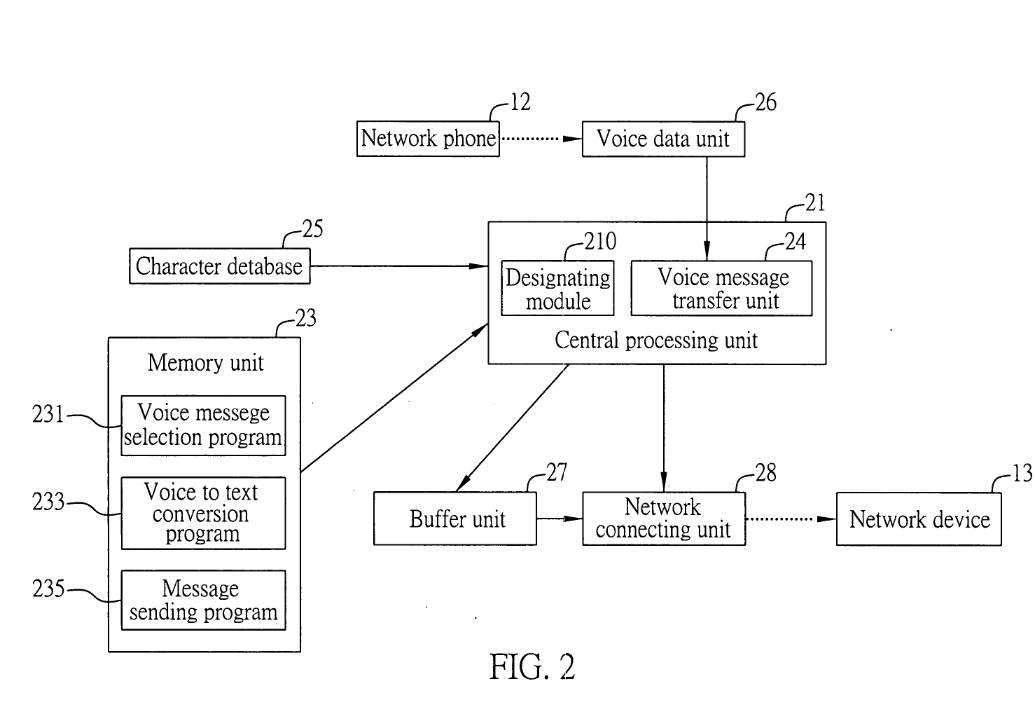

Referring to FIG. 2, a block diagram showing basic function modules of the network phone server of the voice message processing system in accordance with the preferred embodiment of the present invention is illustrated. As shown in the figure, the VoIP server 11 comprises a central processing unit 21, a memory unit 23, a voice message transfer unit 24, a character database unit 25, a voice data unit 26, a buffer unit 27 and a network connection unit 28.

In order to simplify the figure and description thereof, only the elements related to the present invention are illustrated in the software and hardware architectures, other elements not related to the present invention are not illustrated. The central processing unit 21 is employed to control the operations between various electronic elements of the VoIP server 11 and other devices (such as the network phone and the network device) connected to the VoIP server 11, more specifically, to control the operations of the voice message transfer unit 24, character database unit 25, voice data unit 26, buffer unit 27, and the network connecting unit 28 via the program stored in the memory unit 23, such as voice message selection program 231, voice to text conversion program 233, and message sending program 235.

The central processing unit 21 comprises a designating module 210 allowing the user to designate a communication number of a network device in the VoIP server 11 using the network phone or the network device per se by generating a signal to the VoIP server 11. Then upon receiving the signal, the central processing unit 21 is configured to execute the voice message selection program 231 in the memory unit 23.

The voice message selection program 231 allows the central processing unit 21 to control the selection of voice messages received by the network phone 12. The voice message selection program 231 generates a signal and sends to the central processing unit 21 of the VoIP server 11. Once the central processing unit 21 receives the signal, it is actuated to store the voice message in the voice data unit 26.

The voice data unit 26 is employed to store all of the voice messages received by the network phone 26, wherein each of the stored voice messages has a start address and an end address in the voice data unit 26. These addresses facilitate in locating a voice message in the voice data unit 26. Once the central processing unit 21 locates the desired voice message in the voice data unit 26, it sends the voice message to voice message transfer unit 24 of the VoIP server 11, so that the voice message transfer unit 24 stores the start and end addresses of the voice message. The central processing unit then inquires the user whether to select the next voice message received by the network phone 12, if yes, the central processing unit 21 continues the above procedure performed by the voice message selection program 231 of the memory unit 23, and then the central processing unit 21 sends the start address and end address of the next voice message stored in the voice data unit 26 to the voice message transfer unit 24.

The start address and end address of the voice message received by the voice message transfer unit 26 are then used by the voice to text conversion program 233 in the memory unit 23. The central processing unit 21 employs the voice to text conversion program 233 to read the voice message indicated by the start and end addresses in the voice data unit 26. The voice to text conversion program 233 converts the read voice message into a text message to be outputted by the network device 13, which will be detailed in the following description.

The voice to text conversion program 233 is employed by the central processing unit 21 to convert the voice message read by voice message selection program 231 into text message to be outputted by the network device 13. As described above, a selected voice message can be read out from the voice data unit 26 by the central processing unit 21 according to the start address and end address of the voice message indicated by the voice message transfer unit 24. Alternatively, all the voice messages can be directly read out by the central processing unit 21 from the voice data unit 26. The central processing unit 21 converts the analog voice signal into digital signal by analog to digital processing or the like. The central processing unit 21 receives the converted digital signal, and then employs the voice to text conversion program 233 to process and analyze the digital signal, that is, voice frequency information generated by the voice message.

The central processing unit 21 electrically connects to the character database unit 25. The character database unit 25, such as a memory unit like ROM or EEPROM, stores a plurality of specific voice frequencies and corresponding characters in different languages, for example, a Chinese character database (e.g. Chinese voice frequencies with corresponding Chinese characters) or English character database (e.g. Chinese voice frequencies with corresponding English characters). The voice to text conversion program 233 extracts characters from the character database unit 25 that correspond to the voice frequencies obtained by analyzing the voice message, so as to perform conversion of the voice message into a text message to be outputted by the network device 13. The converted text message is then stored in the buffer unit 27.

The message sending program 235 commands the central processing unit 21 of the VoIP server 11 to communicate with the user-designated network device having the communication number, and then sends the text message stored in the buffer unit 27 to the network device 13 via the network connecting unit 28.

The central processing unit 21 commands the buffer unit 27 to detect if the network device 13 has received the text message. Upon receiving an acknowledgement of successful reception from the network device 13, the VoIP server 11 then informs the user about completion of this transmission.

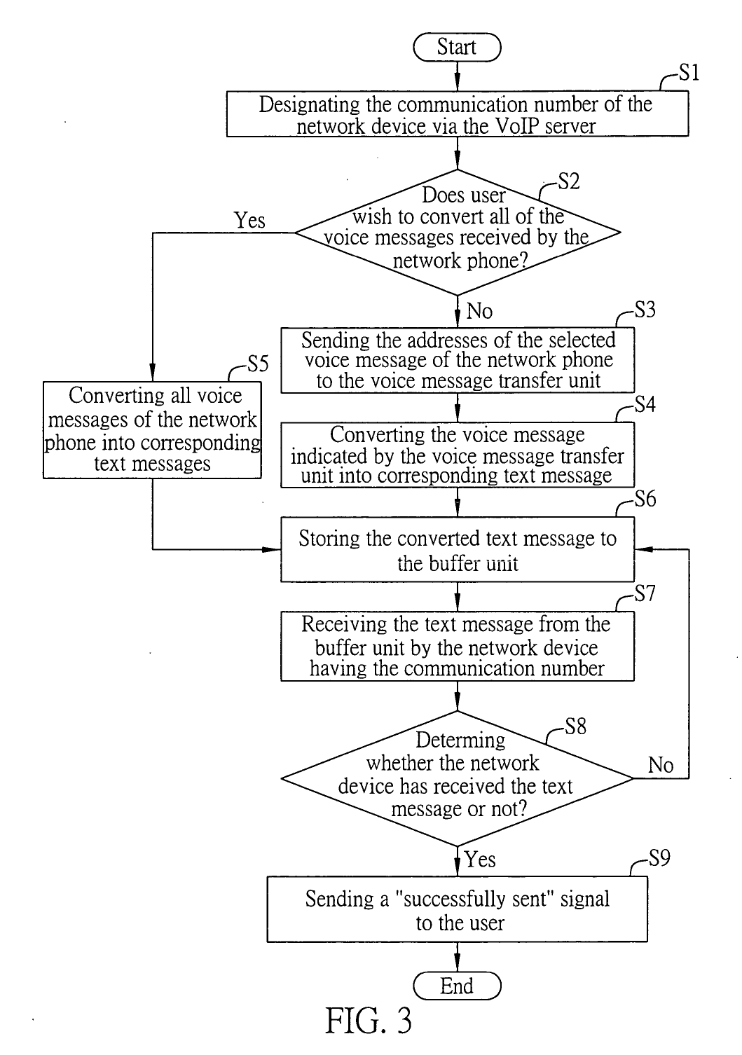

Referring to FIG. 3, a flow chart showing the procedures of a voice message processing method in accordance with the preferred embodiment of the present invention is illustrated. As shown in the figure, the method is employed in the voice message processing system of FIG. 1 above, wherein the network phone 12 and the network device 13 interconnect via the VoIP server 11 to construct a network system.

In step S1, user designates a communication number of a network device 13 via the VoIP server 11 for interconnecting the network phone 12 and the network device 13, next executing step S2.

In step S2, determine if the user selects all the received voice messages to be converted to text messages, if yes, executing step S5; if not, executing step S3.

In step S3, the voice message transfer unit 24 stores the address information (start address and end address) of a voice message selected by the user, next executing step S4.

In step S4, the voice-to-text conversion program 233 in the memory unit 23 of the VoIP server 11 is executed to convert the voice message indicated by the address information stored in the voice message transfer unit 24 into corresponding text message, next executing step S6.

In step S5, the voice-to-text conversion program 233 is executed to convert all the voice messages received by the network phone 12 into corresponding text messages, next executing step S6.

In step S6, the buffer unit 27 of the VoIP server 11 stores the converted text message, next executing step S7.

In step S7, the network device 13 having the designated communication number receives the text message from the buffer unit 27 of the VoIP server 11, next executing step S8.

In step S8, the VoIP server 11 determines if the network device 13 has successfully received the text message sent from the VoIP server 11, if yes, executing step S9, if no, back to step S6 where the VoIP server 11 sends the converted text message again to the network device 13.

In step S9, upon determining that the network device 13 has received the text message, the VoIP server 11 sends out a “successfully sent” signal to the user.

In conclusion, using the voice message processing system and method, the voice message received by the network phone can be output in text message form by the network device connected to the network phone, so the receptions of the messages of the network phone are not limited to the network phone, and the forms of the messages are not limited by that provided by the network phone. Thus, users who cannot get access to the network phone or cannot understand a certain language are now able to access the messages received by the network phone in a flexibility way.

It should be apparent to those skilled in the art that the above description is only illustrative of specific embodiments and examples of the present invention. For example, instead of arranging the memory unit 23, voice message transfer unit 24, character database unit 25, voice data unit 26, buffer unit 27 and network connecting unit 28 in the VoIP server 11 as described, these elements can also be arranged in each of the network phones connected to the VoIP server 11, or even in the network device 13 according to different embodiments. The present invention should therefore cover various modifications and variations made to the herein-described structures and operations of the present invention, provided they fall within the scope of the present invention as defined in the following appended claims.

What is claimed is:

1. A voice message processing system employed to convert voice message received by a network phone into text message to be outputted by a network device connected to the network phone, the voice message processing system comprising:
a voice message receiving module for receiving a voice message from the network phone;
a designating module for designating the communication number of the network device;
a voice to text conversion module for converting the voice message received by the voice message receiving module into a text message to be outputted by the network device; and
a sending module for sending the text message converted by the voice to text conversion module to the network device having the communication number, according to the communication number designated by the designating module, so that the network device outputs the voice message received by the network phone in the text form.

2. The voice message processing system as claimed in claim 1, wherein the voice receiving module comprises a voice message transfer unit for storing the start address and end address of the voice message from the network phone.

3. The voice message processing system as claimed in claim 2, wherein the voice to text conversion module converts the voice message indicated by the addresses stored in the voice message transfer unit.

4. The voice message processing system as claimed in claim 1, wherein the voice message processing system further comprises a character database unit, the character database unit stores a plurality of characters that correspond to the voice message received by the voice message receiving module.

5. The voice message processing system claimed in claim 4, wherein the voice to text conversion module generates voice frequency corresponding to the voice message received by the voice message receiving module, the voice frequency corresponds to the characters stored in the character database unit, so that the voice to text conversion module converts the voice message received by the voice receiving module into text message to be outputted by the network device.

6. The voice message processing system as claimed in claim 1, wherein the voice message processing system further comprises a buffer unit for storing the text message converted from each of the voice messages by the voice to text conversion module.

7. The voice message processing system as claimed in claim 1, wherein the network device is a facsimile apparatus.

8. The voice message processing system as claimed in claim 1, wherein the voice message processing system is arranged in a network server, the network phone interconnects the network device via the network server.

9. The voice message processing system as claimed in claim 1, wherein the voice message processing system is arranged in the network phone.

10. The voice message processing system as claimed in claim 1, wherein the voice message processing system is arranged in the network device.

11. A voice message processing method employed to convert voice message received by a network phone into text message to be outputted by a network device connected to the network phone, the network phone interconnecting the network device via a network server, the voice message processing method comprising:
a user designating a communication number of a network device via the network server so the network device receiving the text message corresponding to the voice message received by the network phone;
the network server upon receiving the voice message by the network phone converting the voice message into text message;
the network server sending the converted text message to the designated network device; and
the network server commanding the designated network device to output the text message converted by the network server.

12. The voice message processing method as claimed in claim 11, wherein the network server further stores all the voice messages from the network phone in a voice data unit.

13. The voice message processing method as claimed in claim 12, wherein the network server further stores the start addresses and end addresses of the voice messages in the voice data unit by a voice message transfer unit.

14. The voice message processing method as claimed in claim 13, wherein the network server converts the voice message indicated by the voice message transfer unit into text message and sends the text message to the network device.

15. The voice message processing method as claimed in claim 11, wherein the network server further comprises a character database unit for storing characters in different language.

16. The voice message processing method as claimed in claim 15, wherein the network server further generates voice frequency corresponding to the received voice message, and the voice frequency corresponding to the characters of the character database unit, so that the network server converts the voice message from the network phone into text message to be outputted by the network device.

17. The voice message processing method as claimed in claim 11, wherein the network server further stores the converted text message in a buffer unit.

18. The voice message processing method as claimed in claim 11, wherein the network device is a facsimile apparatus.
